(19) United States
(12) Patent Application Publication
(10) Pub. No.: US 2021/0278521 A1
(43) Pub. Date: Sep. 9, 2021

(54) RADAR GOLAY CODES FOR REDUCTION OF RANGE SIDELOBES AND INTERFERENCE

(71) Applicant: QUALCOMM Incorporated, San Diego, CA (US)

(72) Inventors: Evgeny LEVITAN, Haifa (IL); Amichai SANDEROVICH, Atlit (IL); Ariel Yaakov SAGI, Haifa (IL); Evyatar HEMO, Kiryat Bialik (IL)

(21) Appl. No.: 16/810,643

(22) Filed: Mar. 5, 2020

(51) Int. Cl. G01S 13/58; G01S 13/28; G06F 17/14; H04J 13/00

(52) U.S. Cl. CPC G01S 13/582; H04J 13/0014; G06F 17/142; G01S 13/288

(57) ABSTRACT

Apparatus and methods are disclosed for determining, at a radar device, range and Doppler velocity based on reduced Doppler-induced radar range sidelobes, including generating code sequence pairs such that a sum of autocorrelations of each code sequence pair has substantially no sidelobes, transmitting a plurality of pulses in an emitted burst, where each pulse of the emitted burst comprises a code sequence pair different from at least one other pulse of the burst such that the autocorrelation sum of the code sequence pairs of the two different pulses has sidelobes, receiving pulses in a reflected burst, each pulse a reflected copy of a corresponding pulse of the emitted burst, generating an autocorrelation sum for each reflected pulse with its corresponding emitted pulse, and determining range and Doppler velocity based on autocorrelation sums, where the sidelobes autocorrelation sums combine incoherently at reduced power.

### TECHNICAL FIELD

Disclosed aspects are generally directed to complementary sequences used in Phase Modulated Continuous Wave (PMCW) radar, and in particular to mitigating effects of Doppler-induced range sidelobes and interference between different radars related to the conventional use of Golay sequences.

### BACKGROUND

The rapid development of autonomous driving technologies raises new requirements for modern automotive radar systems, motivating an evolution from conventional object detection sensors to ultra-high-resolution imaging devices with object recognition and classification capabilities. These radar systems, as envisioned, may provide autonomous vehicles with 4D Radar images (range-azimuth-elevation-velocity) at a real-time refresh rate of 30 frames per second or more.

Conventional radar sensors often use chirp-sequence Frequency Modulation Continuous Wave pulses (FMCW) and digital MIMO techniques with multiple high-speed ADCs and DACs. These components and methods are, however, difficult to adapt for imaging radar without significant implementation complexity and increased hardware costs. Other techniques, such as analog phased-array beam-scanning, hybrid beamforming, and time-division multiplexing MIMO, may be less complex, but are usable at a trade-off with slower scan durations. Moreover, FMCW waveforms have limited flexibility and reduced capabilities for mitigation of interference with nearby radar systems.

Attention has been directed to alternative radar waveforms, including complementary pairs of phase-coded waveforms such as Golay sequences. A useful fundamental property of Golay complementary sequences is that the sum of their autocorrelation functions produces an impulse response function, with the beneficial consequence of zero range sidelobes. However, a problem arises in that Golay sequences are sensitive to Doppler shift, resulting in the introduction of range sidelobes in the autocorrelation sum that may reduce the accuracy of range determinations. Interference may arise, as well, from other radar sources emitting Golay-based radar pulses.

PMCW radar may play an important role in developing automotive radar devices, but when coupled with the promising use of Golay sequences, a corresponding need arises for improved methods of mitigating Doppler-induced effects on range determinations and interference.

### SUMMARY

According to an aspect Aspects of this disclosure are directed to systems and methods for determining range and Doppler velocity based on reduced Doppler-induced radar range sidelobes. Accordingly, aspects include, for example, generating, at a code sequence generator, a plurality of code sequence pairs, where each code sequence pair is such that a sum of autocorrelations (autocorrelation sum) of that code sequence pair has substantially no sidelobes; transmitting, at a radar transmitter, a plurality of pulses in an emitted burst, where each pulse of the emitted burst comprises a code sequence pair of the plurality of code sequence pairs, and each pulse of the emitted burst is different from at least one other pulse of the emitted burst such that an autocorrelation sum of the code sequence pairs of the two pulses that are different has sidelobes; receiving, at a radar receiver, a plurality of pulses in a reflected burst, where each pulse of the reflected burst is a reflected copy of a corresponding pulse of the emitted burst; generating, at a correlator, a plurality of autocorrelation sums, where each autocorrelation sum corresponds with a pulse of the emitted burst and comprises a sum of autocorrelations of the code sequence pair of the pulse of the emitted burst with the code sequence pair of the corresponding pulse of the reflected burst; and determining, at a Doppler processing module, a range and a Doppler velocity based on the plurality of autocorrelation sums, where the sidelobes of the plurality of autocorrelation sums combine incoherently to yield reduced power.

Further aspects provide that each code sequence pair may comprise a pair of phase-coded waveforms, and each code sequence pair may be a complementary pair of Golay sequences, wherein each Golay sequence comprises 1,024 symbols. Each pulse of the emitted burst may be randomly selected from a family of pulses comprising at least two pulses, and each pulse of the family of pulses may be different from every other pulse of the family of pulses such that a sum of autocorrelations of the code sequence pairs of any two pulses of the family of pulses has sidelobes. According to an aspect, the plurality of code sequence pairs may comprise a first pulse and a second pulse, the second pulse the same as the first pulse, and include reversing the pair order of the code sequence pair of the second pulse. In another aspect, for each pulse, the transmissions of the sequences of the code sequence pair may be separated by a duration greater than an expected round-trip duration for the pulse. And in another aspect, the determining may include applying a Fast Fourier Transform to the plurality of autocorrelation sums.

Another aspect is directed to an apparatus for determining range and Doppler velocity with reduced Doppler-induced radar range sidelobes, including a code sequence generator for generating a plurality of code sequence pairs, each code sequence pair such that a sum of autocorrelations of that code sequence pair has substantially no sidelobes, and generating a plurality of pulses in an emitted burst, each pulse of the emitted burst comprising a code sequence pair of the plurality of code sequence pairs, and each pulse of the emitted burst different from at least one other pulse of the emitted burst such that a sum of autocorrelations of the code sequence pairs of the two pulses that are different has sidelobes; a radar transmitter for transmitting the emitted burst; a radar receiver for receiving a plurality of pulses in a reflected burst, each pulse of the reflected burst a reflected copy of a corresponding pulse of the emitted burst; a correlator for generating a plurality of autocorrelation sums, each autocorrelation sum corresponding with a pulse of the emitted burst and comprising a sum of autocorrelations of the code sequence pair of the pulse of the emitted burst with the code sequence pair of the corresponding pulse of the reflected burst; and a Doppler processing module configured to determine a range and a Doppler velocity based on the plurality of autocorrelation sums, the sidelobes of the plurality of autocorrelation sums combining incoherently to yield reduced power.

According to an aspect, each code sequence pair may comprise a pair of phase-coded waveforms, and in accordance with further aspects, each code sequence pair may be a complementary pair of Golay sequences, wherein each Golay sequence may comprise 1,024 symbols. According to an aspect, each pulse of the emitted burst may be randomly selected from a family of pulses comprising at least two pulses, and each pulse of the family of pulses may be different from every other pulse of the family of pulses such that a sum of autocorrelations of the code sequence pairs of any two pulses of the family of pulses has sidelobes. Further, the plurality of code sequence pairs may comprise a first pulse and a second pulse, the second pulse being the same as the first pulse, and further comprise reversing the pair order of the code sequence pair of the second pulse. Regarding another aspect, for each pulse, the transmissions of the sequences of the code sequence pair may be separated by a duration greater than an expected round-trip duration for the pulse. And, according to another aspect, the Doppler processing module may be further configured to apply a Fast Fourier Transform to the plurality of autocorrelation sums.

Another aspect is directed to an apparatus for determining range and Doppler velocity with reduced Doppler-induced radar range sidelobes, including means for generating a plurality of code sequence pairs, each code sequence pair such that a sum of autocorrelations of that code sequence pair has substantially no sidelobes; means for transmitting a plurality of pulses in an emitted burst, where each pulse of the emitted burst may comprise a code sequence pair of the plurality of code sequence pairs, and each pulse of the emitted burst may be different from at least one other pulse of the emitted burst such that a sum of autocorrelations of the code sequence pairs of the two pulses that are different has sidelobes; means for receiving a plurality of pulses in a reflected burst, where each pulse of the reflected burst may be a reflected copy of a corresponding pulse of the emitted burst; means for generating a plurality of autocorrelation sums, where each autocorrelation sum may correspond with a pulse of the emitted burst and comprise a sum of autocorrelations of the code sequence pair of the pulse of the emitted burst with the code sequence pair of the corresponding pulse of the reflected burst; and means for determining a range and a Doppler velocity based on the plurality of autocorrelation sums, where the sidelobes of the plurality of autocorrelation sums may combine incoherently to yield reduced power.

Further aspects provide that each code sequence pair of each pulse may comprise a pair of phase-coded waveforms, and each code sequence pair may be a complementary pair of Golay sequences. Additionally, each pulse of the emitted burst may be randomly selected from a family of pulses comprising at least two pulses, and each pulse of the family of pulses may be different from every other pulse of the family of pulses such that a sum of autocorrelations of the code sequence pairs of any two pulses of the family of pulses has sidelobes. According to an aspect, the plurality of code sequence pairs may comprise a first pulse and a second pulse, where the second pulse is the same as the first pulse, and further comprise reversing the pair order of the code sequence pair of the second pulse. According to another aspect, for each pulse, the transmissions of the sequences of the code sequence pair may be separated by a duration greater than an expected round-trip duration for the pulse. Additionally, the means for determining a range and a Doppler velocity may include means for applying a Fast Fourier Transform to the plurality of autocorrelation sums.

Another aspect is directed to a non-transitory computer-readable storage medium comprising code, which, when executed by a processor on a radar device, causes a determination of a range and a Doppler velocity with reduced Doppler-induced radar range sidelobes, the non-transitory computer-readable storage medium including code for generating a plurality of code sequence pairs, each code sequence pair such that a sum of autocorrelations of that code sequence pair has substantially no sidelobes; code for transmitting a plurality of pulses in an emitted burst, each pulse of the emitted burst comprising a code sequence pair of the plurality of code sequence pairs, and each pulse of the emitted burst different from at least one other pulse of the emitted burst such that a sum of autocorrelations of the code sequence pairs of the two pulses that are different has sidelobes; code for receiving a plurality of pulses in a reflected burst, each pulse of the reflected burst a reflected copy of a corresponding pulse of the emitted burst; code for generating a plurality of autocorrelation sums, each autocorrelation sum corresponding with a pulse of the emitted burst and comprising a sum of autocorrelations of the code sequence pair of the pulse of the emitted burst with the code sequence pair of the corresponding pulse of the reflected burst; and code for determining a range and a Doppler velocity based on the plurality of autocorrelation sums, the sidelobes of the plurality of autocorrelation sums combining incoherently to yield reduced power.

According to further aspects, each code sequence pair may comprise a pair of phase-coded waveforms, and each code sequence pair may be a complementary pair of Golay sequences. According to an aspect, the non-transitory computer-readable storage medium may further include code for randomly selecting each pulse of the emitted burst from a family of pulses comprising at least two pulses, where each pulse of the family of pulses is different from every other pulse of the family of pulses such that a sum of autocorrelations of the code sequence pairs of any two pulses of the family of pulses has sidelobes. According to another aspect, the non-transitory computer-readable storage medium may further include code for randomly selecting each pulse of the plurality of pulses of the emitted burst from among a first pulse and a second pulse, wherein the second pulse may be the same as the first pulse but with its code sequence pair in reverse pair order. According to an aspect, the non-transitory computer-readable storage medium may further include code for separating the transmissions of the sequences of the code sequence pair for each pulse by a duration greater than an expected round-trip duration for the pulse. And, according to yet another aspect, the code for determining a range and a Doppler velocity may include code for applying a Fast Fourier Transform to the plurality of autocorrelation sums.

### BRIEF DESCRIPTION OF THE DRAWINGS

FIG. 1 is an illustration of how the summed autocorrelations of a pair of complementary Golay sequences produce an impulse response function.

FIG. 2 is an amplitude plot depicting amplitudes of autocorrelations of another example pair of Golay sequences.

FIG. 3A is a power plot of a sum of autocorrelations of a further example pair of Golay sequences.

FIG. 3B is an amplitude plot of a sum of autocorrelations of the example pair of Golay sequences, demonstrating the impulse response function and zero-summing sidelobes.

FIG. 4 depicts an example of a Golay-based pulse burst.

FIGS. 5A and 5B demonstrate an effect of Doppler shift on the autocorrelation sum of a single pulse comprising a Golay pair.

FIG. 6 is an example Range-Doppler map depicting range sidelobes related to a burst of identical pulses, each pulse comprising a Golay code sequence pair.

FIG. 7 is an example Range-Doppler map depicting range sidelobes related to a burst comprising randomized Golay pulses.

FIG. 8 is an example Range-Doppler map depicting a ridge effect arising from interference between two different bursts comprising Golay-based pulses.

FIGS. 9A-C depict bursts of Golay-based pulses that are randomized according to methods disclosed herein.

FIG. 10 is a flowchart of an example method of determining range and Doppler velocity on the basis of reduced Doppler-induced radar range sidelobes.

FIG. 11 is a functional block diagram depicting a radar device for determining range and Doppler velocity on the basis of reduced Doppler-induced radar range sidelobes in the use of Golay complementary code sequences.

### DETAILED DESCRIPTION

Aspects disclosed herein are directed to improved methods of mitigating Doppler-induced range sidelobes related to the use of Golay complementary sequences in PMCW-based radar devices. Further aspects are directed to mitigating radar-based interference through the use of same.

As discussed above, rapid developments in autonomous and semi-autonomous driving technologies have newly motivated advances in modern automotive radar systems such as ultra-high-resolution imaging devices with object recognition and classification capabilities. Such radar systems should provide autonomous vehicles with 4D radar images (i.e., having range-azimuth-elevation-velocity information) at real-time refresh rates of 30 frames per second or more. Typical specifications for automotive imaging radar may further include range coverages of up to 300 meters, fields-of-view of up to 90 degrees, capacities for velocity detections ranging ±50 m/s, high range resolutions of 0.5 meters, angular resolutions of 1 degree, and Doppler resolutions of 0.5 m/s. These evolving requirements of the automotive industry are driving next-generation radar systems to be equipped with large transmit and receive antenna arrays including, for example, hundreds of elements, with the use of high bandwidth signals (˜1 GHz), short pulse repletion intervals (e.g., on the order of 20 μsec) and relatively long observation times (e.g., on the order of 4 msec).

Significant additional challenges lie in mutual interferences between nearby automotive radars. That is, if substantially every vehicle on the road is equipped with one or more of only a few different radar types, interferences between similar types implemented on different vehicles may be significant enough to comprise operation and raise safety concerns.

Conventional radar sensors may use chirp-sequence modulation pulses (such as in FMCW), and all digital MIMO methods with multiple high-speed ADCs and DACs. These systems are capable of simultaneously transmitting signals from multiple transmit antennas and simultaneously receiving signals at multiple receive antennas. However, scaling up existing MIMO radars from relatively few transmit/receive (Tx/Rx) chains to the tens and hundreds of Tx/Rx chains required for imaging radar would severely impact hardware cost, making this approach very complex and practicably unattractive.

Other techniques such as those based on time-multiplexing, including analog phased-array beam-scanning, hybrid beamforming, and time-division multiplexing MIMO, may be more cost-effective. Time-multiplexing may help to reduce the number of Tx/Rx chains, but their functions are then typically performed at a slower scan time. Moreover, FMCW chirp sequences tend to be relatively long (e.g., on the order of tens of microseconds) rendering time-multiplexing methods inadequate for achieving high Doppler resolution and radar frame rate requirements. Further, FMCW waveforms have limited flexibility and critically reduced capabilities for interference mitigation.

By contrast, certain radar waveforms, such as Golay sequences, comprise complementary pairs of phase-coded waveforms. As mentioned above, an advantageous property of a Golay complementary sequence (pair) is that a sum of its autocorrelation functions results in an impulse response function, which ideally has zero range sidelobes. Golay-based pulses can also be much shorter than FMCW pulses (on the order of 1 μs), which may enable efficient multiplexing methods for fast scanning of sectors, antennas, and subarrays, as well as more practical and cost-effective radar schemes that can be implemented with lower numbers of Tx/Rx chains. Additionally, there exist many separable and easily switchable waveforms in any given family of Golay sequences that can be effectively implemented for interference reduction. That is, various radars may use different families of Golay codes for mutual interference mitigation.

Several other properties of Golay sequences make this waveform attractive for automotive radars, including a high energy pulse with low peak power (i.e., low Peak to Average Power Ratio (PAPR)), substantially constant amplitude (pulse shape dependence), orthogonality between certain Golay pairs (useful in MIMO radar methods), and efficient, flexible hardware implementation of a Golay correlator (on the order of log₂(N)).

Despite the many beneficial properties arising from the use of Golay sequences, they are not widely used in automotive radar due to a relatively high sensitivity to Doppler shift. That is, Doppler shift introduces a phase ramp over the received signal, which compromises ideal sidelobe cancellation, resulting conventionally in significantly high range sidelobes.

Accordingly, methods and apparatus are disclosed herein provide for significant reduction of Doppler-induced range sidelobes, as well as interference suppression and the reduction of false detections of targets positioned beyond an operationally maximal range of the radar.

These and other aspects are disclosed in the following description and related drawings to show specific examples relating to exemplary aspects. Alternative aspects will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects disclosed herein.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

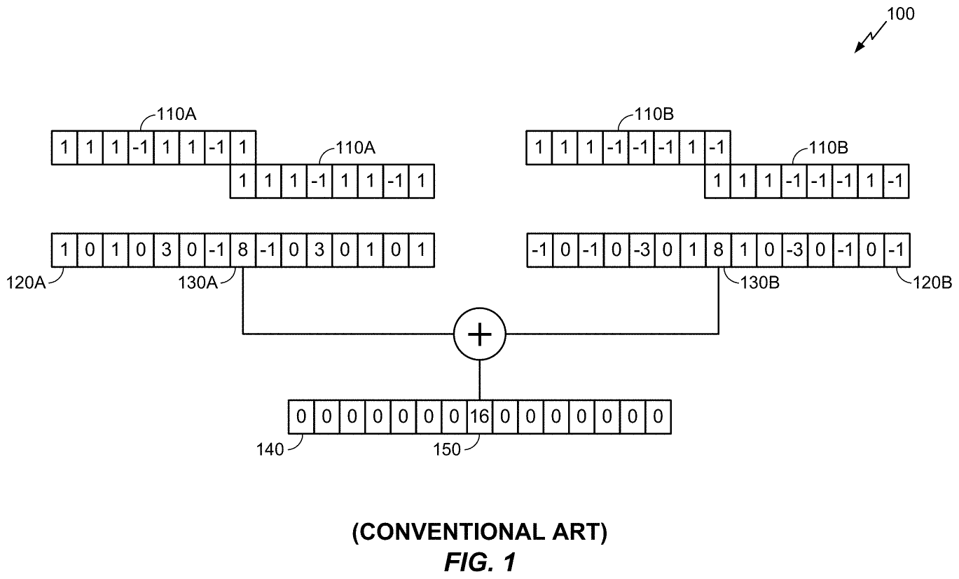

FIG. 1 is an illustration 100 of how the summed autocorrelations of a pair of Golay complementary sequences ideally produce an impulse response function. A first code sequence 110A is autocorrelated to generate its autocorrelation sequence 120A. Likewise, a second code sequence 110B is autocorrelated to generate its autocorrelation sequence 120B. For these first and second code sequences 110A, 110B, as Golay complementary sequences, a beneficial property lies in summing the autocorrelations 120A, 120B, to produce an autocorrelation sum sequence 140 (also “sum of autocorrelations,” herein) manifesting an ideal Dirac delta function (also referred to herein as “ideal impulse response,” or “impulse response,” or “impulse response function”). Expressed more specifically, two complementary Golay sequences (also referred to herein as “Golay code sequences,” or simply “code sequences”) satisfy the following relationship:

C_{A}(k)C_{B}(k)=2δ_{δ,0}, for all −(L−1)≤k≤L−1. Eq. (1)

That is, the sum of the autocorrelation C_{A}(k) of Golay sequence A with the autocorrelation C_{B}(k) of Golay sequence B yields a Dirac delta function having twice the maximum power of either of the autocorrelation sequences C_{A}(k) and C_{B}(k). Indeed, it may be observed in the present example of FIG. 1 that except for the identical values of ‘8’ at the center bins 130A, 130B of autocorrelation sequences 120A, 120B, the values at the remaining bins are negative-opposites between the two sequences. Thus, when the two sequences are summed, as in the autocorrelation sum sequence 140, all that remains is the value at the center bin 150, which is the sum of the values of the center bins 130A, 130B, of the two autocorrelation sequences 120A, 120B. That is, all of the other bins of the autocorrelation sequences 120A, 120B have canceled each other out, leaving only the value of 16 in the center bin, which is an ideal impulse response.

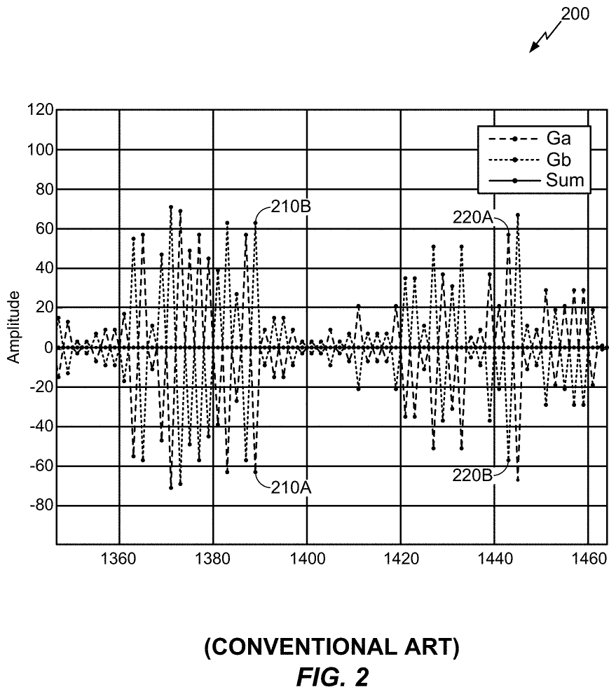

FIG. 2 is an amplitude plot 200 depicting the amplitudes of autocorrelations of another example pair of Golay sequences, Ga and Gb. It may be observed, also, that the autocorrelation plots of Ga and Gb, as shown, represent a portion of one “side” of the respective autocorrelation functions, for ease of explanation, and do not include the center bin or bins on the other “side.” In the plot 200, the two autocorrelations may be viewed as two waveforms having opposite peaks at any given bin. For example, the (negative) peak 210A of the autocorrelation of Ga is exactly opposite the (positive) peak 210B of the autocorrelation of Gb. Similarly, the (positive) peak 220A of the autocorrelation of Ga is exactly opposite the (negative) peak 220B of the autocorrelation of Gb. The result of summing the two autocorrelation sequences is, therefore, a sequence of bins with zero-values, similar to the sum of autocorrelations sequence 140 in FIG. 1. This positive/negative relationship between the autocorrelations of Golay sequences Ga and Gb holds true at any bin, other than the center bins, and underscores the property of Golay code sequence pairs referred herein to as “sidelobe cancelation” in the their autocorrelation sum. It will be appreciated that in each autocorrelation sequence, the peaks may also be thought of as “sidelobes,” as they will be referred to hereinafter.

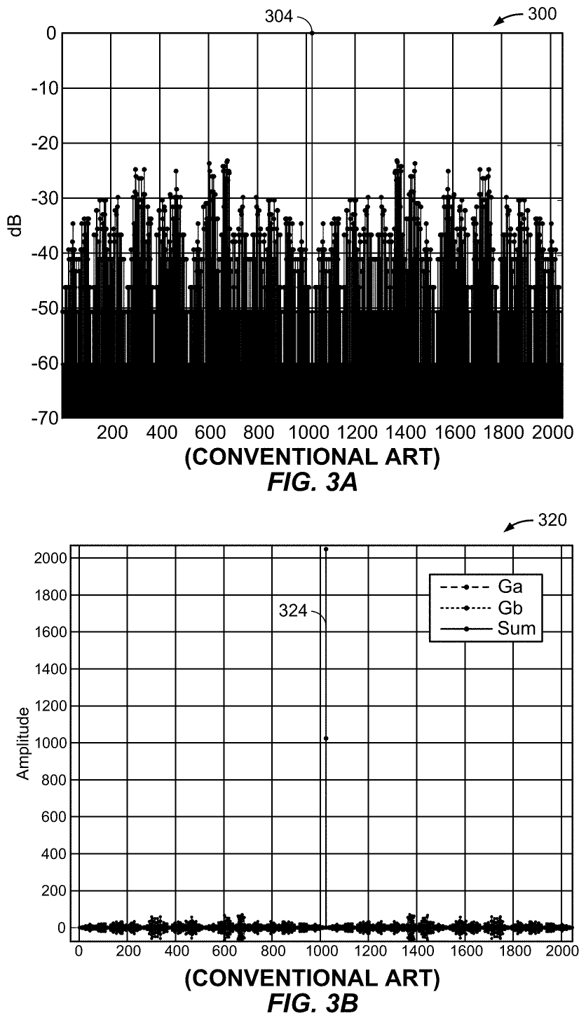

FIG. 3A is a plot 300 depicting the powers per bin of the autocorrelations of a further example pair of Golay sequences, also referred to here as Ga and Gb. Here, power is expressed as an absolute value, and the powers of the peaks of the two autocorrelation sequences add to clearly show the sidelobes of the two individual sequences. Note the peak 304 of 0 dB at the sequence center, bin 1000 (of 2000). By contrast, FIG. 3B depicts autocorrelation amplitudes of the same example pair of Golay sequences, Ga and Gb, and an impulse function 324 resulting from the sum of the autocorrelations. It may be observed that the sidelobes at the off-center bins substantially between bins 0 and 1000, and 1000 and 2000, are symmetrical above and below the horizontal (i.e., the “zero amplitude”) axis. Thus, the summation of the upper and lower sidelobes results in zero-valued bins, i.e., sidelobe cancelation, as demonstrated similarly in FIG. 2.

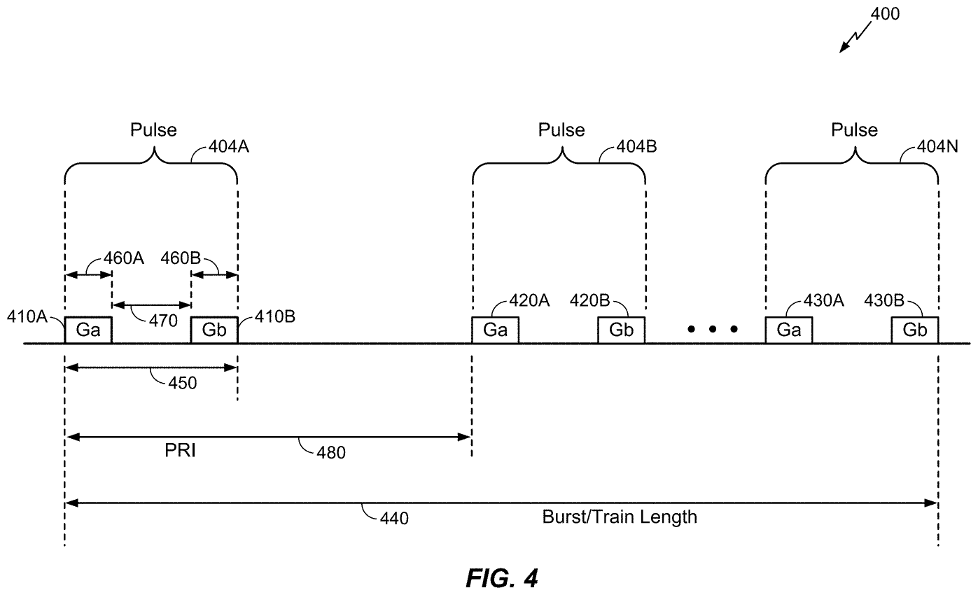

FIG. 4 depicts an example of a generalized Golay pulse burst (also known as a “train”) 400, where, in this case, the pulses each comprise a Golay code sequence pair, Ga and Gb. The pulse burst 400 comprises a plurality of pulses 404A-N, all of which are identical.

Referring to a single pulse instance, pulse 404A comprises a Golay code sequence pair Ga 410A and Gb 410B. Ga 410A and Gb 410B are a Golay complementary pair in that together they express the behaviors discussed above regarding Golay sequence pairs, in particular with regard to sidelobe cancelation in the autocorrelation sum. Each pulse 404 has the same pulse duration 450 as pulse 404A, which includes two code sequence durations 460A, 460B, and a sequence separation 470. In an embodiment, the sequence separation 470 is at least half the round trip delay for a reflected radar transmission, and is in turn tied to an assumed maximal range of the radar device. The pulses 404 are separated in the pulse burst 400 by a pulse repetition interval (PRI) 480, and the burst 400 has a burst (train) length 440. These durations and separations apply to all pulses 404 of the pulse burst 400.

During an emission of burst 400 of the plurality of pulses 404A-N, each pulse 404 is emitted in turn from the radar device, separated by the PRI from the preceding and following pulse 404, completes a round trip to and from a reflecting surface, and is received at the radar device. Focusing on the single pulse 404A, the code sequence Ga 410A is emitted and completes a round trip to and from a reflecting surface (which is no further away than the maximum detection range), and is received at the radar device before the code sequence Gb 410B is transmitted in accordance with the sequence separation 470. A range estimate to the reflecting surface may be estimated based on the autocorrelation sum for the pulse 404A (elaborated below). Over a burst 400 of N pulses 404A-N, N range estimates may therefore be determined.

As will be discussed in more detail below, a Doppler shift, caused by relative movement between the radar device and the reflecting surface, may cause range sidelobes in a sum of autocorrelations between an emitted pulse and its reflected copy, if not corrected. That is, referring to FIG. 2, for example, the sidelobes of the autocorrelations of the Golay sequence pair (i.e., the autocorrelation of Ga with Ga, and the autocorrelation of Gb with Gb) zero out when summed due to the sidelobe cancelation property of the Golay sequences. However, when the emitted Golay pair is similarly “autocorrelated” with the reflected copy of itself, phase effects of the Doppler shift affecting the reflected copy weaken the advantageous effects of the sidelobe cancelation property. Also, it should be understood that the term “autocorrelation,” as used herein, is intended may apply as well to what may be recognized as a “cross-correlation,” when an emitted Golay sequence pair is correlated not with itself but with its reflected copy. That is, in that sense the emitted sequence and reflected copy are not the same waveforms and would be “cross-correlated” rather than “autocorrelated.” On the other hand, the reflected copy is based on the emitted sequence, so an “autocorrelation” may also be regarded as appropriate. For ease of explanation herein, and since the processes are otherwise functionally identical, the term “autocorrelation” may be used in both instances. The term “cross-correlation” may be used when the waveforms are clearly from different sources.

Referring to again to FIG. 4, in an example embodiment, the symbol frequency may be about 600 MHz, with a corresponding range resolution of about 25 cm, and a maximum detection range of about 300 m, for a round trip delay of about 2 μs for each transmission. Accordingly, the sequence durations 460A, 460B of the Golay code sequences Ga and Gb, each comprising 1,024 symbols, is about 1.7 μs at 600 MHz. The PRI 480 may be about 20 μs, so for a burst of N=100 pulses 404A-N, the burst length 440 is about 2 ms, giving a Doppler resolution of about 1 m/s.

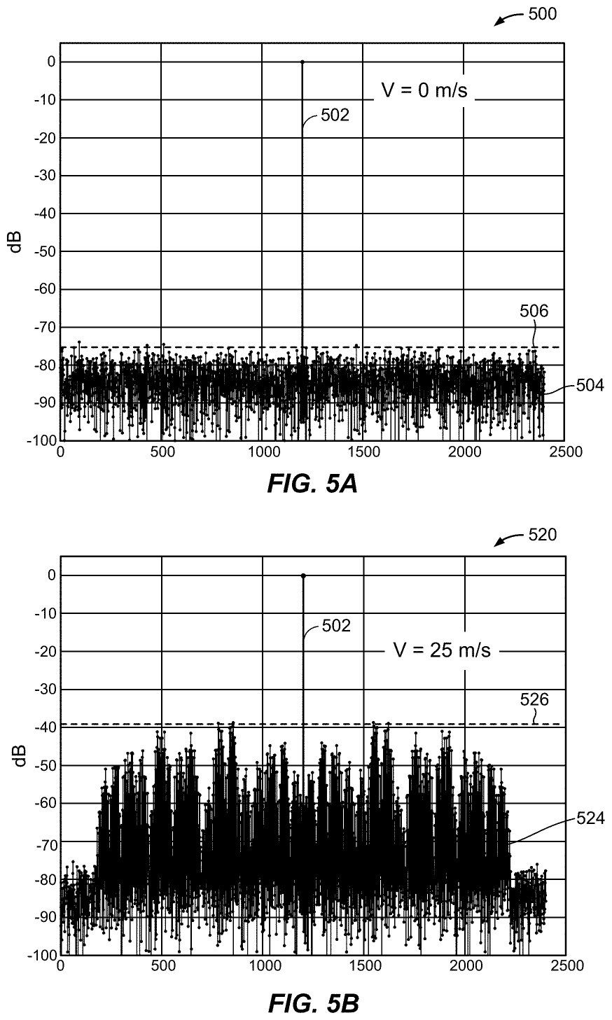

FIGS. 5A and 5B illustrate an effect of Doppler shift on a single pulse comprising a Golay pair, Ga and Gb (e.g., Ga 410A and Gb 410B of FIG. 4). FIG. 5A is a plot of an autocorrelation sum 500 of an emitted pulse (e.g., pulse 404A) with its received, reflected copy. In this case, the relative velocity between the radar device and the reflecting surface is V=0 m/s, representing a baseline (“ideal”) condition in which the sidelobe cancelation property of Golay sequences is in force. With the sidelobes of the autocorrelation sum 500 canceled, there remains essentially noise-level energy 504, manifesting a noise floor 506 at about −75 dB. The impulse function 502 corresponding with a range estimate projects clearly over the noise-level energy 504 in accordance with the advantageous qualities of the Golay sequence pair.

FIG. 5B is a similar plot of an autocorrelation sum 520 of the emitted pulse with its received, reflected copy. By contrast, however, the relative velocity between the radar device and the reflecting surface is now V=25 m/s. Due to the relative velocity, a Doppler shift causes a phase ramp between the Golay code sequences Ga and Gb, which in turn interferes with the sidelobe cancelation property of the Golay sequences. That is, summing the autocorrelation of the emitted Ga sequence and its corresponding received, reflected copy, with the autocorrelation of the emitted Gb sequence and its corresponding received, reflected copy, does not result in the cancelation of the respective sidelobes because of the Doppler phase effects on the received, reflected copies of Ga and Gb. Consequently, instead of a noise floor 506 at −75 dB, sidelobes 524 appear in the autocorrelation sum 520 with sidelobe peak power 526 at about −39 dB, in this example. The impulse function 502 corresponding with a range estimate projects much less over the sidelobe peak power 526, and the sidelobe cancelation property of the Golay sequence pair is severely impacted. Moreover, the sidelobes 524 may impair the detectability of another target that may be weaker than the target associated with the impulse function 502. That is, an impulse function associated with another target having the same Doppler velocity, but at a different range, may be masked by the sidelobes 524, thus limiting the dynamic range of the radar device. It can further be shown that the sidelobe power increase and decrease in tandem with the relative velocity. That is, as shown in Table 1, example values indicate that as the relative velocity (i.e., Doppler shift) increases, so does the power of the autocorrelation sum (range) sidelobes.

TABLE 1
Sidelobe Power vs. Doppler

| Velocity/Doppler (m/s) | Sidelobe Power (dB) |
|---|---|
| 0 | −inf |
| 5 | −53 |
| 25 | −39 |
| 50 | −33 |
| 100 | −27.5 |
| 270 | −21 |

The plots shown in FIGS. 5A and 5B depict the effects of Doppler shift on a single pulse comprising a Golay code sequence pair, Ga and Gb. The discussion now moves to the effects of Doppler shift on a burst 400 of identical Golay code sequence pairs 404A-N. Generally, Doppler shift introduces phase effects on a single pulse, i.e., a single pair of Golay code sequences, and further Doppler-induced phase effects are introduced as sidelobe distortions across a burst. As will be elaborated below, for a burst of identical pulses (i.e., Golay code sequence pairs) the sidelobes of the autocorrelation sums for the pulses are substantially coherent, the coherency arising from the similar autocorrelations sums repeated for all of the pulses of the burst. This coherency causes power to accumulate at certain frequency bins when a Fast Fourier Transform (FFT, for Doppler processing) is performed over the length of the burst.

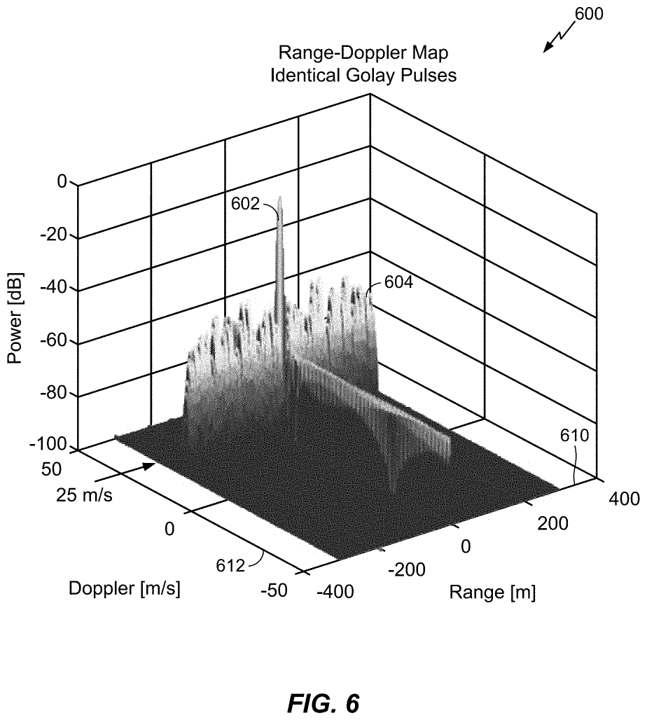

FIG. 6 is an example Range-Doppler map 600 depicting range sidelobes 604 (also, “range sidelobe ridge”) related to a burst of identical pulses, each pulse comprising a Golay code sequence pair. Such a Range-Doppler map 600 is useful for envisioning Doppler processing, where range and Doppler velocity with respect to a reflecting surface may be based on the impulse response 602. Rows are defined here as being parallel to the Range-axis 610. Each row is populated by an autocorrelation sum for a single pulse in a burst, where each data point of the row corresponds with a “range bin.” Columns are defined as parallel to the Doppler-axis 612. Each column is populated with the results of an FFT performed on a data series, the data series comprising the range bin value (autocorrelation sum value) for the same range bin across all of the rows, and thus across all of the pulses of the burst. The Range-Doppler map 600 depicts also that an FFT window has been applied to results of each column, and is a Chebyshev 60 dB window in this case. It will be appreciated that other FFT window types are often used.

The Range-Doppler map 600 depicts the range sidelobe ridge 604 at a Doppler velocity of 25 m/s, corresponding similarly to the autocorrelation sum depicted in FIG. 5B. In this example, the power at the peaks of the range sidelobe ridge 604 is about −39 dB, which is the consequence of coherent accumulation, across the burst, of range sidelobe power in the autocorrelation sums of the identical pulses (Golay code sequence pairs). It will be appreciated that while in this case the power of the range sidelobe peaks at a velocity of 25 m/s reaches about −39 dB, the power at the range sidelobe peaks for higher velocities (see Table 1) may reach higher power levels by coherency, making accurate determinations of both range and Doppler increasingly difficult, and mask weaker targets at the same velocity, as discussed above.

According to the results shown in the Range-Doppler map 600, and in view of the discussion above, it should therefore be clear that a method for reducing the effects of coherency in autocorrelation sums among the identical pulses comprising Golay code sequence pairs is advantageous in Doppler processing. Accordingly, embodiments described herein address this problem by intentionally diversifying the pulses of a burst such that instead of high range sidelobe powers caused by coherency, the sidelobe cancelation property of Golay sequences is mitigated and a substantially uniform noise floor results instead. Consequently, not only is a Range-Doppler peak (such as impulse 602) more clearly detectable, but weaker targets in the presence of the stronger primary target may also be detectable. Further embodiments include intentionally diversifying families of PMCW pulses that are not Golay-based, by which a similar effect of reduced sidelobes in the Range-Doppler map may be achieved due to non-coherent combining of sidelobes of the various individual pulse correlations within a burst.

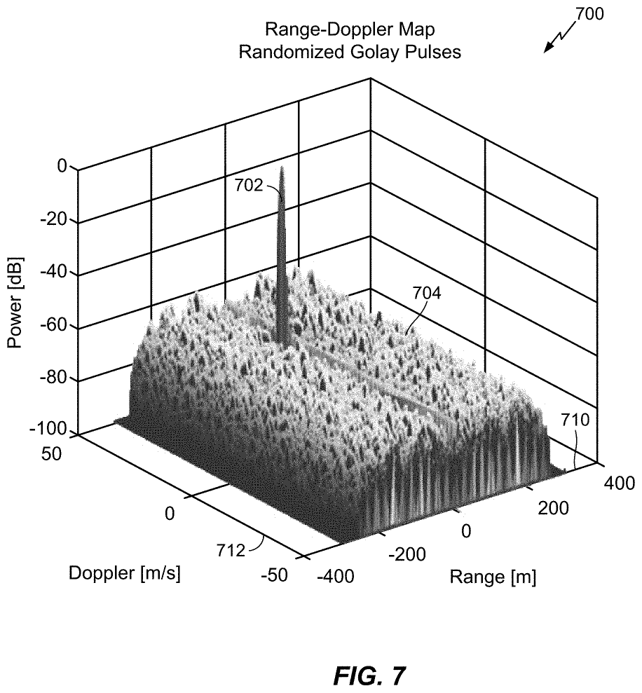

FIG. 7 is an example Range-Doppler map 700 depicting range sidelobes 704 related to a burst comprising randomized pulses, each pulse comprising a Golay code sequence pair. Each row is populated by an autocorrelation sum for a single pulse in a burst, but now the pulses comprise randomized Golay code sequence pairs. The effect is generally that the autocorrelation sum of the Golay code sequence pair of each pulse (row) is not necessarily the same as that of the previous or following pulse, or in some embodiments, any of the other pulses of the burst. The FFTs performed on the columns generate a substantially uniform noise floor 704, which is the result of creating incoherence among the range sidelobes of the autocorrelation sums by randomizing the pulses and thus mitigating the sidelobe cancelation property of Golay sequences. Indeed, the results show that the range sidelobe ridge 604 is substantially suppressed, essentially replaced by uniform the noise floor 704 at about −65 dB. The Range-Doppler impulse response therefore has more relative power in comparison with the corresponding impulse response 602, which corresponds with burst comprising identical Golay-based pulses. The reduction in power at the noise floor 704 may be estimated according to the relationship 10 log₁₀(N). Thus, for a burst of N=100 pulses, the power of the noise floor 704, based on randomized Golay-based pulses, should be reduced by about −20 dB below the power of the range sidelobes 604, which are based on identical Golay-based pulses. Herein, the power at the noise floor 704 is deemed “reduced” in comparison to the higher relative powers of range sidelobes 604 based on a similar plurality of autocorrelation sums corresponding with an emitted burst conventionally comprising pulses of identical code sequence pairs, as discussed with regard to FIG. 6.

For a strongly reflecting surface positioned beyond a defined maximal range of the emitting radar device, the echo of a Golay sequence, Ga 410A, of a pulse 404A, reflected from this surface may coincide on reception with the subsequently emitted Gb 410B of the same pulse 404A. An autocorrelation sum based on reflected Ga 410A and Gb 410B sequences should substantially, or partially (e.g., due to Doppler effects), mitigate range sidelobes, as discussed above. However, in this case, an undesired range sidelobe may nonetheless appear at the autocorrelator output. Over the burst 400, when the Golay-based pulses 404A-N are identical, this range sidelobe is coherently constructed in a range-Doppler map, similar to that of FIG. 6. According to an aspect, by randomizing the Golay pulses 404A-N of the burst 400 as described above, this coherently constructed range sidelobe may be advantageously mitigated similarly as to Doppler-induced sidelobes, discussed above.

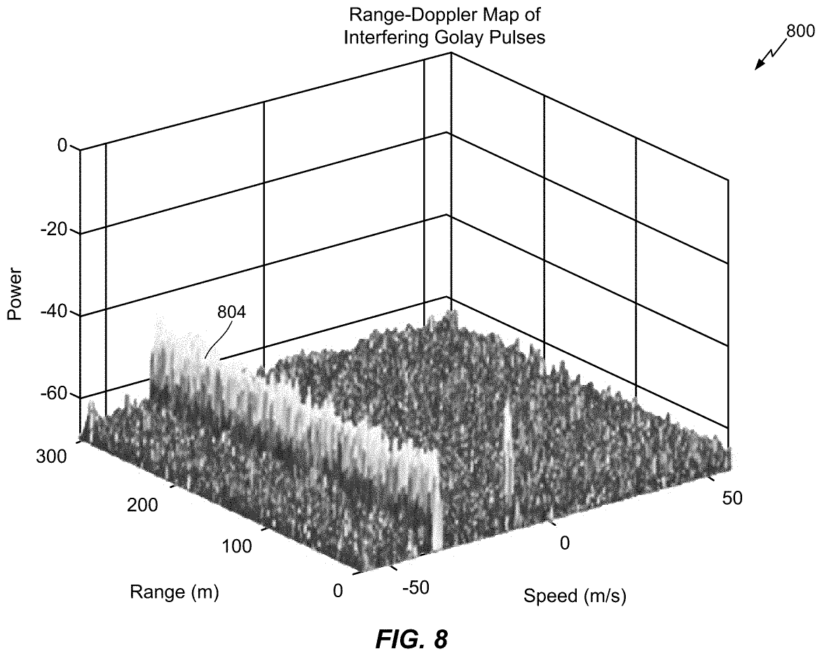

FIG. 8 is an example Range-Doppler map 800 depicting a ridge effect 804 arising from interference between two Golay-based bursts originating from different emitting sources. This condition may present, for example, when two radars emit bursts of pulses at the same PRI 480, but the bursts use different, but respectively identical, Golay code sequences. Or, the different bursts may comprise the same Golay code sequences, but there is a high frequency offset between them. A radar device emitting one of the bursts may then receive a reflected copy of its own emitted burst in addition to an interfering burst from another radar device. The result of a cross-correlation of the received, legitimate reflected copy and the interfering Golay code sequences may include sidelobes of a certain type at the correlator output. In particular, with the pulses of both bursts having the same PRI 480, the cross-correlation result for the affected pulses may coherently combine and produce the ridge effect 804 shown in the range-Doppler map 800. Similarly to the mitigation of Doppler-induced sidelobes in autocorrelation sums discussed above, emitting randomized/different pulses across the bursts for one, or both, of the interfering radars will also mitigate any coherency between the pulses. The advantageous result is that instead of the strong sidelobes of the ridge effect 804 induced by interference, there will be an increase of the noise floor of the entire range-Doppler map (not shown), similar to the noise floor 704 for Doppler-induced sidelobe mitigation.

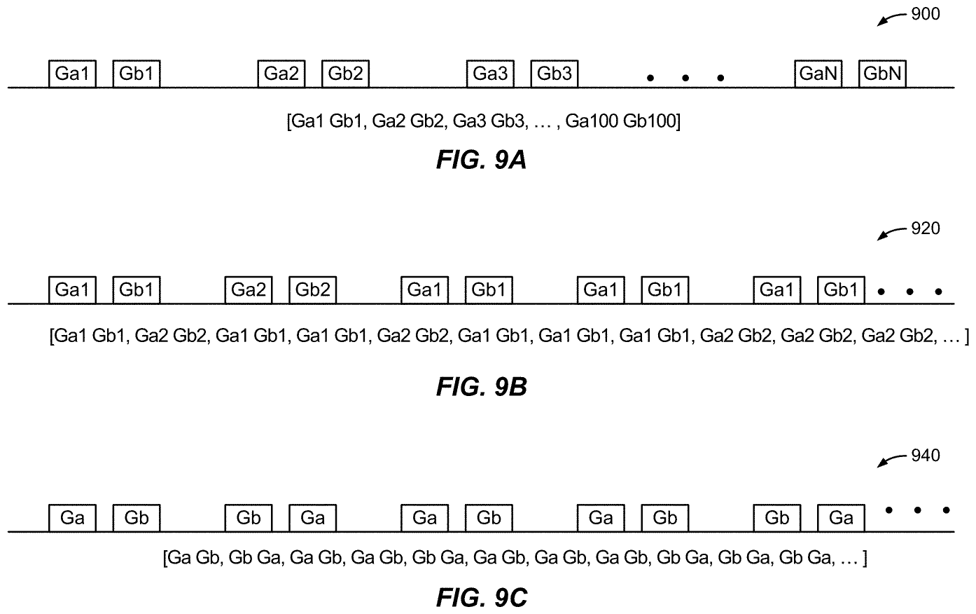

FIGS. 9A-C depict example Golay pulse bursts 900, 920, 940, which illustrate various methods for randomizing pulses 404 as disclosed herein. As discussed, the effect of randomizing the Golay code sequences of each pulse 404 of a burst 400 is to mitigate coherencies of the sidelobes of the autocorrelation sums corresponding with each of the plurality of pulses 404A-N of the burst 400. The advantageous results are a substantial mitigation of range sidelobe power offset only by a modest increase in power of a uniform noise floor, as shown in the related range-Doppler map of FIG. 7. It is to be understood that the descriptions and relationships of, and between, a pulse burst 400, pulse 404, and the component Golay code sequence pairs Ga 410A and Gb 410B, for example, illustrated in FIG. 4, hold equally for a pulse burst comprising pulses (i.e., Golay code sequence pairs) that are different and/or randomized, as discussed below. It will also be appreciated that there may be multiple approaches to randomizing Golay code sequences. A family of Golay code sequence pairs (pulses) can number quite high, though still be easily generated, and be all different. In an embodiment, each pulse of an emitted burst is randomly selected from a family of pulses that comprises at least two pulses, where each pulse of the family is different from every other pulse of the family such that the autocorrelation sums of the code sequence pairs of any two pulses of the family generates sidelobe (as opposed to an ideal impulse function).

FIG. 9A depicts, according to an aspect, an example Golay pulse burst 900 in which the pulses are selected from a Golay family in which for every pulse the comprised Golay code sequence pair is different from every other Golay sequence pair. Consequently, for example, a sum of the autocorrelations (equally, cross-correlations) of code sequences Ga1-Gb1 with Ga2-Gb2 will include sidelobes that are in turn incoherent with the sidelobes of a sum of the autocorrelations of code sequences Ga2-Gb2 with Ga3-Gb3. According to another aspect, the family of Golay code sequence pairs (i.e., pulses) may number fewer than (i.e., be a subset of) the N pulses depicted in FIG. 9A. In that case, the pulses composing the burst 900 are randomly selected from the smaller family of Golay code sequences. In this example, the Golay code sequence pairs of the family of pulses exhibit high diversity in that no two sequence pairs are alike. This approach may be appropriate where resources are adequate to generate and/or store a burst length of Golay code sequence pairs for a full, or partially full, Golay pulse family. In an embodiment, resource availabilities at the radar device may drive a determination of a particular size of a subset of the full pulse family that is best suited for operation and/or resource management at the radar device.

FIG. 9B depicts, according to an aspect, an example Golay pulse burst 920 in which every Golay code sequence pair Ga1-Gb1, Ga2-Gb2 (i.e., pulse), of the emitted burst is randomly selected from a family of pulses comprising two pulses. Additionally, the two pulses of the family are different from each other such that a sum of autocorrelations (autocorrelation sum) of the code sequence pairs of the two pulses has sidelobes. Further, the sidelobes of the two autocorrelation sums are incoherent. Similarly to Golay pulse burst 900, a sum of the autocorrelations (cross-correlations) of code sequences Ga1-Gb1 with Ga2-Gb2 will include sidelobes that are adequately incoherent over the span of the burst 920 by virtue of random selection and ordering. By contrast to Golay pulse burst 900, Golay pulse burst 920 is simpler, comprising only two code sequences, and thus commensurately less demanding of memory and computational resources at the radar device.

FIG. 9C depicts, according to a further aspect, an example Golay pulse burst 940 comprising Golay code sequence pairs selected from Golay code sequence pair Ga-Gb and its reverse-order version, Gb-Ga. That is, for example, for a first pulse and a second pulse of a plurality of pulses of an emitted burst, the pair order of the code sequence pair of the second pulse is the reverse of the pair order of the code sequence pair of the first pulse, and each pulse of the plurality of pulses of the emitted burst is randomly selected from among the first and second pulses. Similarly to Golay pulse burst 920, a sum of the autocorrelations (cross-correlations) of code sequences Ga-Gb with Gb-Ga will include sidelobes that are adequately incoherent over the span of the burst 930 by virtue of random selection and ordering. According to this example, Golay pulse burst 940 may be constructed and sufficiently randomized using a single Golay code sequence pair, thus advantageously minimizing memory and computational resources at the radar device.

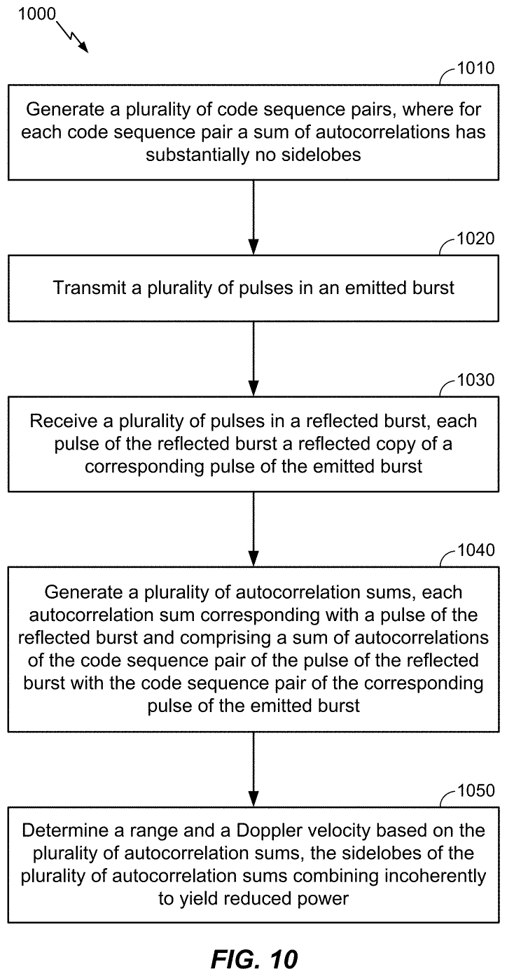

FIG. 10 is a flowchart of an example method 1000 of determining range and Doppler velocity on the basis of reduced Doppler-induced radar range sidelobes. At block 1010, a plurality of code sequence pairs may be generated, each code sequence pair such that a sum of autocorrelations (also, herein, an “autocorrelation sum”) of that code sequence pair has substantially no sidelobes. In this context, having substantially no sidelobes refers to the advantageous sidelobe cancelation property of Golay code sequence pairs, discussed above at least with regard to FIGS. 1 and 2. In an embodiment, the generating may be performed at a code sequence generator.

At block 1020, a plurality of pulses is transmitted in an emitted burst, where each pulse of the emitted burst comprises a code sequence pair of the plurality of code sequence pairs, and each pulse of the emitted burst is different from at least one other pulse of the emitted burst such that an autocorrelation sum (i.e., sum of the autocorrelations) of the code sequence pairs comprising each of the two pulses that are different has sidelobes. In this context, having sidelobes refers to an intentional mitigation of the sidelobe cancelation property of Golay code sequence pairs. Aspects provide that each code sequence pair of the plurality of code sequence pairs may comprise a pair of phase-coded waveforms, each code sequence pair may be a complementary pair of Golay sequences, and each Golay sequence may comprise 1,024 symbols. Aspects further provide that pulses of the emitted burst may be randomly selected from a family of pulses comprising at least two pulses, such that a sum of autocorrelations of the code sequence pairs of any two pulses of the family of pulses has sidelobes. According to another aspect, pulses of the emitted burst may be randomly selected from among a first pulse and a second pulse, wherein the second pulse is the same as the first pulse with its code sequence pair in reverse pair order.

In an embodiment, the transmitting may be performed at a radar transmitter. In another embodiment, the transmitting may be performed at a radar transceiver. Also, for each pulse, the transmissions of the sequences of the code sequence pair may be separated by a duration (i.e., PRI 480) greater than an expected round-trip duration for the pulse from a reflecting surface.

At block 1030, a plurality of pulses in a reflected burst is received, each pulse of the reflected burst a reflected copy of a corresponding pulse of the emitted burst. The reflected burst results from the emitted burst reflecting from a surface, typically a target within (though not necessarily) the operational range of the radar device. In an embodiment, the receiving may be performed at a radar receiver. In another embodiment, the receiving may be performed at a radar transceiver.

At block 1040, a plurality of autocorrelation sums may be generated, each autocorrelation sum of the plurality of autocorrelation sums corresponding with a pulse of the emitted burst, and comprising a sum of autocorrelations of the code sequence pair of the pulse of the emitted burst with the code sequence pair of the corresponding pulse of the reflected burst. In an embodiment, the autocorrelation sums may be generated at a correlator. Note that, as discussed above, autocorrelations and cross-correlations may be performed in the same manner, and differ in that like, or similar, code sequence pairs originating from a common source may be regarded herein as being autocorrelated, whereas correlations of code sequence pairs originating from different sources may be more appropriately indicated as being cross-correlated.

At block 1050, a range and a Doppler velocity may be determined based on the plurality of autocorrelation sums, where, advantageously, the range sidelobes based on the plurality of autocorrelation sums combine incoherently to yield reduced power. Here, and as mentioned above, power is deemed “reduced” in comparison to the higher relative powers of range sidelobes based on a similar plurality of autocorrelation sums corresponding with an emitted burst conventionally comprising pulses of identical code sequence pairs. In an embodiment, the reduction in power may be estimated according to the relationship 10 log₁₀(N), where N is the number of pulses in the emitted burst. As discussed above, a uniform noise floor may be generated based on incoherency of the range sidelobes of the autocorrelation sums. In an embodiment, the determination of a range and a Doppler velocity may be performed at a Doppler processing module. In an embodiment, the determining at block 1050 may include the application of a Fast Fourier Transform (FFT) to the plurality of autocorrelation sums. The Doppler processing is also discussed above in relation to FIGS. 6 and 7.

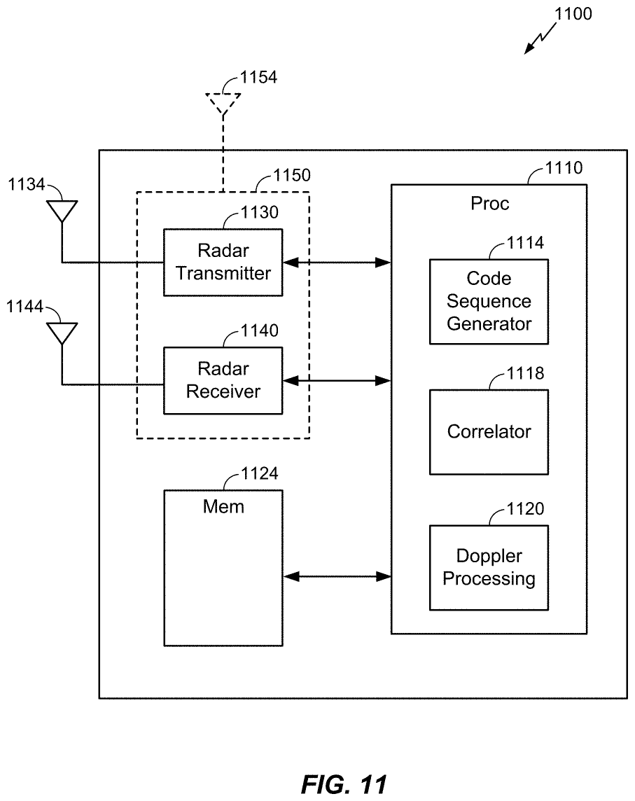

FIG. 11 is a functional block diagram depicting a radar device 1100 for determining range and Doppler velocity on the basis of reduced Doppler-induced radar range sidelobes in the use of Golay complementary code sequences. In the example illustrated, the radar device 1100 may include a processor 1110 communicatively coupled with a memory 1124. Also included may be a radar transmitter 1130 communicatively coupled with the processor 1110, and functionally coupled with a transmitting antenna 1134. Also included may be, similarly, a radar receiver 1140 communicatively coupled with the processor 1110, and functionally coupled with a receiving antenna 1144. Embodiments provide that a radar transceiver 1150 coupled to a transceiver antenna 1154 may functionally aggregate a radar transmitter 1130 and radar receiver 1140, to perform the functions described herein for the radar transmitter 1130 and radar receiver 1140. The processor 1110 may itself include a code sequence generator 1114, a correlator 1118, and a Doppler processing module 1120, or the functionalities thereof. It will be appreciated that the code sequence generator 1114, correlator 1118, and Doppler processing module 1120 may be modules hosted at the processor 1110, or be instantiated off-processor all, some, together, or separately, in various dedicated functional elements. The memory 1124, while illustrated as an element separate from the processor 1110, may be a component thereof. It will be appreciated that there are many possibilities for distributing and/or aggregating the various functionalities described with regard to the radar device 1100, and the examples cited herein are not intended to be limiting.

Accordingly, the code sequence generator 114 may be configured to generate a plurality of code sequence pairs, where each code sequence pair is such that a sum of autocorrelations of that code sequence pair has substantially no sidelobes. The code sequence generator 114 may be further configured to generate a plurality of pulses in an emitted burst, each pulse of the emitted burst comprising a code sequence pair, and each pulse of the emitted burst different from at least one other pulse of the emitted burst such that a sum of autocorrelations (i.e., cross-correlations) of the code sequence pairs of the two pulses that are different has sidelobes.

The radar transmitter 1130 may be configured to transmit the emitted burst via the transmitting antenna 1134. In an embodiment, the radar transceiver 1150 may be so configured to transmit the emitted burst via the transceiver antenna 1154. Aspects provide that each code sequence pair may comprise a pair of phase-coded waveforms, each code sequence pair may be a complementary pair of Golay sequences, and each Golay sequence may comprise 1,024 symbols. For each pulse, as well, the transmissions of the sequences comprising the code sequence pair may be separated by a duration (i.e., sequence separation 470) greater than an expected round-trip duration for the pulse upon reflection from a reflecting surface. Each pulse of the emitted burst comprises a code sequence pair, where each pulse of the emitted burst is different from at least one other pulse of the emitted burst such that an autocorrelation sum of the code sequence pairs comprising each of the two pulses that are different has sidelobes. Aspects provide that pulses of the emitted burst may be randomly selected from a family of pulses comprising at least two pulses, such that a sum of autocorrelations of the code sequence pairs of any two pulses of the family of pulses has sidelobes. According to another aspect, pulses of the emitted burst may be randomly selected from among a first pulse and a second pulse, wherein the second pulse is the same as the first pulse with its code sequence pair in reverse pair order.

The radar receiver 1140 may be configured to receive via the receiving antenna 1144 a plurality of pulses in a reflected burst, each pulse of the reflected burst a reflected copy of a corresponding pulse of the emitted burst. In an embodiment, the receiving may be performed at the radar transceiver 1150 via transceiver antenna 1154.

The correlator 1118 may be configured to generate a plurality of autocorrelation sums, where each autocorrelation sum of the plurality of autocorrelation sums corresponds with a pulse of the emitted burst, and comprises a sum of autocorrelations of the code sequence pair of the pulse of the emitted burst with the code sequence pair of the corresponding pulse of the reflected burst.

The Doppler processing module 1120 may be configured to determine a range and a Doppler velocity based upon the plurality of autocorrelation sums (i.e., the sums of autocorrelations of pulses of the emitted burst with the reflected burst), such that range sidelobes based on the plurality of autocorrelation sums combine incoherently, resulting in reduced power, and a uniform noise floor may be generated based on incoherency of the range sidelobes. Reiterating, power is deemed “reduced,” in the instant context, in comparison to the higher relative powers of range sidelobes based on a similar plurality of autocorrelation sums corresponding with an emitted burst comprising pulses of identical code sequence pairs. In an embodiment, the reduction in power may be estimated according to the relationship 10 log₁₀(N), where N is the number of pulses in the emitted burst. In an embodiment, the Doppler processing module 1120 may be configured to apply a Fast Fourier Transform to the plurality of autocorrelation sums.

The radar device 1100 may further include a bus (not shown) interconnecting various components corresponding with the functional blocks and modules described.

Those having skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those having skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art.

An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC, which may reside in a radar device 1100. In the alternative, the processor and the non-transitory computer-readable medium may be discrete components in the radar device 1100.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects, those skilled in the art will appreciate that various changes and modifications could be made herein without departing from the scope of the disclosure as defined by the appended claims. Furthermore, in accordance with the various illustrative aspects described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method of determining range and Doppler velocity based on reduced Doppler-induced radar range sidelobes, comprising:
generating, at a code sequence generator, a plurality of code sequence pairs, each code sequence pair such that a sum of autocorrelations (autocorrelation sum) of that code sequence pair has substantially no sidelobes;
transmitting, at a radar transmitter, a plurality of pulses in an emitted burst,
each pulse of the emitted burst comprising a code sequence pair of the plurality of code sequence pairs, and
each pulse of the emitted burst different from at least one other pulse of the emitted burst such that an autocorrelation sum of the code sequence pairs of the two pulses that are different has sidelobes;
receiving, at a radar receiver, a plurality of pulses in a reflected burst, each pulse of the reflected burst a reflected copy of a corresponding pulse of the emitted burst;
generating, at a correlator, a plurality of autocorrelation sums, each autocorrelation sum corresponding with a pulse of the emitted burst and comprising a sum of autocorrelations of the code sequence pair of the pulse of the emitted burst with the code sequence pair of the corresponding pulse of the reflected burst; and
determining, at a Doppler processing module, a range and a Doppler velocity based on the plurality of autocorrelation sums, the sidelobes of the plurality of autocorrelation sums combining incoherently to yield reduced power.

2. The method of claim 1, wherein each code sequence pair comprises a pair of phase-coded waveforms.

3. The method of claim 1, wherein each code sequence pair is a complementary pair of Golay sequences.

4. The method of claim 3, wherein each Golay sequence comprises 1,024 symbols.

5. The method of claim 1, wherein:
each pulse of the emitted burst is randomly selected from a family of pulses comprising at least two pulses; and
each pulse of the family of pulses is different from every other pulse of the family of pulses such that a sum of autocorrelations of the code sequence pairs of any two pulses of the family of pulses has sidelobes.

6. The method of claim 1, wherein the plurality of code sequence pairs comprises a first pulse and a second pulse, the second pulse the same as the first pulse; and further comprising reversing the pair order of the code sequence pair of the second pulse.

7. The method of claim 1, wherein for each pulse, the transmissions of the sequences of the code sequence pair are separated by a duration greater than an expected round-trip duration for the pulse.

8. The method of claim 1, wherein said determining includes applying a Fast Fourier Transform to the plurality of autocorrelation sums.

9. An apparatus for determining range and Doppler velocity with reduced Doppler-induced radar range sidelobes, comprising:
a code sequence generator for:
generating a plurality of code sequence pairs, each code sequence pair such that a sum of autocorrelations of that code sequence pair has substantially no sidelobes, and
generating a plurality of pulses in an emitted burst, each pulse of the emitted burst comprising a code sequence pair of the plurality of code sequence pairs, and each pulse of the emitted burst different from at least one other pulse of the emitted burst such that a sum of autocorrelations of the code sequence pairs of the two pulses that are different has sidelobes;
a radar transmitter for transmitting the emitted burst;
a radar receiver for receiving a plurality of pulses in a reflected burst, each pulse of the reflected burst a reflected copy of a corresponding pulse of the emitted burst;
a correlator for generating a plurality of autocorrelation sums, each autocorrelation sum corresponding with a pulse of the emitted burst and comprising a sum of autocorrelations of the code sequence pair of the pulse of the emitted burst with the code sequence pair of the corresponding pulse of the reflected burst; and
a Doppler processing module configured to determine a range and a Doppler velocity based on the plurality of autocorrelation sums, the sidelobes of the plurality of autocorrelation sums combining incoherently to yield reduced power.

10. The apparatus of claim 9, wherein each code sequence pair comprises a pair of phase-coded waveforms.

11. The apparatus of claim 9, wherein each code sequence pair is a complementary pair of Golay sequences.

12. The apparatus of claim 11, wherein each Golay sequence comprises 1,024 symbols.

13. The apparatus of claim 9, wherein:
each pulse of the emitted burst is randomly selected from a family of pulses comprising at least two pulses; and
each pulse of the family of pulses is different from every other pulse of the family of pulses such that a sum of autocorrelations of the code sequence pairs of any two pulses of the family of pulses has sidelobes.

14. The apparatus of claim 9, wherein the plurality of code sequence pairs comprises a first pulse and a second pulse, the second pulse the same as the first pulse; and further comprising reversing the pair order of the code sequence pair of the second pulse.

15. The apparatus of claim 9, wherein for each pulse, the transmissions of the sequences of the code sequence pair are separated by a duration greater than an expected round-trip duration for the pulse.

16. The apparatus of claim 9, wherein said Doppler processing module is further configured to apply a Fast Fourier Transform to the plurality of autocorrelation sums.

17. An apparatus for determining range and Doppler velocity with reduced Doppler-induced radar range sidelobes, comprising:
means for generating a plurality of code sequence pairs, each code sequence pair such that a sum of autocorrelations of that code sequence pair has substantially no sidelobes;
means for transmitting a plurality of pulses in an emitted burst,
each pulse of the emitted burst comprising a code sequence pair of the plurality of code sequence pairs, and
each pulse of the emitted burst different from at least one other pulse of the emitted burst such that a sum of autocorrelations of the code sequence pairs of the two pulses that are different has sidelobes;
means for receiving a plurality of pulses in a reflected burst, each pulse of the reflected burst a reflected copy of a corresponding pulse of the emitted burst;
means for generating a plurality of autocorrelation sums, each autocorrelation sum corresponding with a pulse of the emitted burst and comprising a sum of autocorrelations of the code sequence pair of the pulse of the emitted burst with the code sequence pair of the corresponding pulse of the reflected burst; and
means for determining a range and a Doppler velocity based on the plurality of autocorrelation sums, the sidelobes of the plurality of autocorrelation sums combining incoherently to yield reduced power.

18. The apparatus of claim 17, wherein each code sequence pair of each pulse comprises a pair of phase-coded waveforms.

19. The apparatus of claim 17, wherein each code sequence pair is a complementary pair of Golay sequences.

20. The apparatus of claim 17, wherein:
each pulse of the emitted burst is randomly selected from a family of pulses comprising at least two pulses; and
each pulse of the family of pulses is different from every other pulse of the family of pulses such that a sum of autocorrelations of the code sequence pairs of any two pulses of the family of pulses has sidelobes.

21. The apparatus of claim 17, wherein the plurality of code sequence pairs comprises a first pulse and a second pulse, the second pulse the same as the first pulse; and, further comprising reversing the pair order of the code sequence pair of the second pulse.

22. The apparatus of claim 17, wherein for each pulse, the transmissions of the sequences of the code sequence pair are separated by a duration greater than an expected round-trip duration for the pulse.

23. The apparatus of claim 17, wherein said means for determining a range and a Doppler velocity includes means for applying a Fast Fourier Transform to the plurality of autocorrelation sums.

24. A non-transitory computer-readable storage medium comprising code, which, when executed by a processor on a radar device, causes a determination of a range and a Doppler velocity with reduced Doppler-induced radar range sidelobes, the non-transitory computer-readable storage medium comprising:
code for generating a plurality of code sequence pairs, each code sequence pair such that a sum of autocorrelations of that code sequence pair has substantially no sidelobes;
code for transmitting a plurality of pulses in an emitted burst,
each pulse of the emitted burst comprising a code sequence pair of the plurality of code sequence pairs, and
each pulse of the emitted burst different from at least one other pulse of the emitted burst such that a sum of autocorrelations of the code sequence pairs of the two pulses that are different has sidelobes;
code for receiving a plurality of pulses in a reflected burst, each pulse of the reflected burst a reflected copy of a corresponding pulse of the emitted burst;
code for generating a plurality of autocorrelation sums, each autocorrelation sum corresponding with a pulse of the emitted burst and comprising a sum of autocorrelations of the code sequence pair of the pulse of the emitted burst with the code sequence pair of the corresponding pulse of the reflected burst; and
code for determining a range and a Doppler velocity based on the plurality of autocorrelation sums, the sidelobes of the plurality of autocorrelation sums combining incoherently to yield reduced power.

25. The non-transitory computer-readable storage medium of claim 24, wherein each code sequence pair comprises a pair of phase-coded waveforms.

26. The non-transitory computer-readable storage medium of claim 24, wherein each code sequence pair is a complementary pair of Golay sequences.

27. The non-transitory computer-readable storage medium of claim 24, further comprising code for randomly selecting each pulse of the emitted burst from a family of pulses comprising at least two pulses, wherein each pulse of the family of pulses is different from every other pulse of the family of pulses such that a sum of autocorrelations of the code sequence pairs of any two pulses of the family of pulses has sidelobes.

28. The non-transitory computer-readable storage medium of claim 24, further comprising code for randomly selecting each pulse of the plurality of pulses of the emitted burst from among a first pulse and a second pulse, wherein the second pulse is the same as the first pulse with its code sequence pair in reverse pair order.

29. The non-transitory computer-readable storage medium of claim 24, further comprising code for separating the transmissions of the sequences of the code sequence pair for each pulse by a duration greater than an expected round-trip duration for the pulse.

30. The non-transitory computer-readable storage medium of claim 24, wherein said code for determining a range and a Doppler velocity includes code for applying a Fast Fourier Transform to the plurality of autocorrelation sums.
